(19) United States
(12) Patent Application Publication
(10) Pub. No.: US 2023/0145620 A1
(43) Pub. Date: May 11, 2023

(54) TRADING CARD CASING PROTECTOR

(71) Applicant: ALPHA CLASS, INC., Clearfield, PA (US)

(72) Inventor: Eric E. CUMMINGS, Clearfield, PA (US)

(73) Assignee: ALPHA CLASS, INC., Clearfield, PA (US)

(21) Appl. No.: 17/971,916

(22) Filed: Oct. 24, 2022

Related U.S. Application Data
(60) Provisional application No. 63/276,852, filed on Nov. 8, 2021.

(51) Int. Cl. G09F 1/10; A45C 11/18

(52) U.S. Cl. CPC G09F 1/10; A45C 11/18

(57) ABSTRACT

A protector includes a substrate and a first sheet of a first material supported by the substrate. The first sheet of a first material may be configured to be removed from the substrate and coupled to a casing for a collectable. A kit may include the protector and a first template. The template may have a body including at least one surface configured to guide an instrument to facilitate cutting the protector.

### CROSS REFERENCE TO RELATED APPLICATIONS

This application claims the benefit of U.S. Provisional Patent Application No. 63/276,852, filed Nov. 8, 2021, which is hereby incorporated by reference in its entirety for all purposes as if fully set forth herein.

### FIELD

The disclosed embodiments generally relate to a casing protector, and, more particularly, to a trading card casing protector.

### BACKGROUND

The trading card industry is increasing in popularity, and thus the visual integrity of each card is increasingly important whether for display or sale. One variable in determining the appeal for either the display or for the sale of a card extends beyond the appearance of the card itself. The case, which holds a card, can negatively affect the visual appeal of a card. If, for example, the casing is scratched, clouded, discolored, or dented, the visual appeal is lessened both for display and for the potential sale of the card.

In the industry, a card of value may first be placed in a soft plastic sleeve. The card and sleeve may then slid into a harder plastic sleeve, of which may vary in dimension, in thickness or in general shape-appearance. If the card itself has an appearance of higher quality or if the owner finds heightened sentimental value in a card, an owner may pay to register the card and send the card away to a professional grading company in the hopes that the card will later be returned and be identified as having a grade attributed to it which is as near perfect as possible, i.e., is a “10.” When a graded card is sent back to its owner, the card is permanently encased in a thick casing. Each grading company's casing differs in appearance but, currently, the dimensions of casings are within a similar range of one another. A graded card case can however be subject to scratching, denting or other damage, all of which affects the appearance of the case and card.

### SUMMARY

To overcome the problems described above and other problems of prior art, an embodiment of the present disclosure provides a protector, including a first sheet of material having a first length and a first width, a second sheet of material that is different from the first sheet of material, the second sheet of material is affixed to the first sheet of material, wherein the first sheet of material is configured to be removed from the second sheet of material and affixed to a card protector case.

In an embodiment, the first sheet of material is a plastic or a tempered glass, wherein the first sheet of material includes a transparent front side and an adhesive back side. In an embodiment, the second sheet of material is a backing. In an embodiment, the second sheet of material is affixed to the first sheet of material by the adhesive.

The protector can further include a tab feature to assist in removing the first sheet of material from the second sheet of material.

The protector can further include a first sheet of material that includes at least one of a perforation or a cut-line, wherein the first sheet of material is configured to be removed from the second sheet of material and affixed to a card case protector.

The protector can further include a first sheet of material having a first length and a first width, a second sheet of material that is different from the first sheet of material, and the second sheet of material is affixed to the first sheet of material, wherein the first sheet of material includes at least one of a perforation or a cut-line dividing the first sheet into a first portion, the first portion having a second width and a second length, and the second portion having a third width and a third length, the third length being different from the second length, and wherein the first sheet of material is configured to be removed from the second sheet of material and affixed to a card case protector.

An embodiment of the present disclosure provides a kit, including at least one protector and a plurality of different sized templates configured to provide a guide for cutting a first sheet, wherein the first sheet of material is configured to be removed from a second sheet of material and affixed to a card case protector.

In an embodiment, the first sheet of material has a first length and a first width and the second sheet of material is different from the first sheet of material, the second sheet of material is affixed to the first sheet of material.

In some embodiments, a protector includes a substrate and a first sheet of a first material supported by the substrate. The first sheet of a first material may be configured to be removed from the substrate and coupled to a casing for a collectable.

In some embodiments, the first sheet of material may be a plastic or a tempered glass.

In some embodiments, the first sheet may have a first length and a first width that corresponds to a length and a width of the casing.

In some embodiments, the first sheet may have a first length and a first width that corresponds to a length and a width of a first predetermined area of the casing.

In some embodiments, the first area may include a slab area.

In some embodiments, the first area may include a card area.

In some embodiments, the first sheet may include at least one of a first perforation or a first cut. The at least one of the first perforation or the first cut may at least partially enclose a first protective area having a second length and a second width.

In some embodiments, at least one of the second length and the second width may be less than the first length and the first width.

In some embodiments, the first protective area may correspond to a slab area of the casing.

In some embodiments, the first protective area may correspond to a card area of the casing.

In some embodiments, the first sheet may include at least one of a second perforation or a second cut. The at least one of the second perforation or the second cut may at least partially enclosing a second protective area having a third length and a third width.

In some embodiments, at least one of the third length and the third width may be different from at least one of the second length and the second width.

In some embodiments, the third length may be the same as the second length and the third width may be the same as the second width.

In some embodiments, the first sheet of material may be formed from a material selected from the group consisting of plastic and glass.

In some embodiments, at least one of the first sheet of material or the substrate may include a removal feature configured to facilitate removal of the first sheet of material from the substrate.

In some embodiments, a kit may include a protector and a first template. The protector may include a substrate and a first sheet of a first material supported by the substrate. The first sheet of a first material may be configured to be removed from the substrate and to be coupled to a casing. The template may have a body including at least one surface configured to guide an instrument to facilitate cutting the protector.

The kit of claim 16, wherein the body of the template includes an outer periphery and an inner periphery, at least one of the outer periphery and the inner periphery including the at least one surface and having dimensions corresponding to a dimension of an area to be protected on a casing.

In some embodiments, the area to be protected on the casing may include a slab area.

In some embodiments, wherein the area to be protected on the casing may include a card area.

In some embodiments, the body of the template may define a first guide extending through the body from a first side to a second side. The guide may include the at least one surface.

In some embodiments, the guide may at least partially enclose a first protective area having a first length and a first width.

In some embodiments, the first length may correspond to a length of a first area of the casing to be protected and the first width may correspond to a width of the first area of the casing to be protected.

In some embodiments, the first area to be protected may include a slab area of the casing.

In some embodiments, the first area to be protected may include a card area of the casing.

In some embodiments, the body of the template may define a second guide extending through the body from the first side to the second side and may at least partially include a second protective area having a second length and a second width.

In some embodiments, the at least one of the first length or the first width may differ from the second length or the second width.

In some embodiments, the first length may be the same as the second length. The first width may be the same as the second width.

### BRIEF DESCRIPTION OF THE DRAWINGS

FIG. 1A is a plan view of one example of a casing that encases a slab and a card, in accordance with some embodiments;

FIG. 1B is a side view of the casing that encases a slab and a card, in accordance with some embodiments;

FIG. 2A is a side view of one example of a casing protector, in accordance with some embodiments;

FIG. 2B is a side view of the casing protector disposed on a substrate, in accordance with some embodiments;

FIG. 3A is a plan view of one example of a protector, in accordance with some embodiments;

FIG. 3B is a cross-sectional view of the protector illustrated in FIG. 3A taken along line 3B-3B in FIG. 3A, in accordance with some embodiments;

FIG. 4A is a plan view of another example of a protector, in accordance with some embodiments;

FIG. 4B is a cross-sectional view of the protector illustrated in FIG. 4A taken along line 4B-4B in FIG. 4A, in accordance with some embodiments;

FIG. 4C is a cross-sectional view of the protector illustrated in FIG. 4A taken along line 4C-4C in FIG. 4A, in accordance with some embodiments;

FIG. 5A is a top side plan view of one example of a template in accordance with some embodiments;

FIG. 5B is a cross-sectional view of the template illustrated in FIG. 5A taken along line 5B-5B in FIG. 5A, in accordance with some embodiments;

FIG. 6A is a top side plan view of another example of a template in accordance with some embodiments;

FIG. 6B is a cross-sectional view of the template illustrated in FIG. 6A taken along line 6B-6B in FIG. 6A, in accordance with some embodiments; and

FIG. 6C is a cross-sectional view of the template illustrated in FIG. 6A taken along line 6C-6C in FIG. 6A, in accordance with some embodiments.

### DETAILED DESCRIPTION

The present disclosure describes, according to various examples and embodiments, a case protector for trading cards, such as a graded trading card disposed in a case. The disclosed devices and kits advantageously enable card collectors to enjoy the functionality of stacking their graded (and encased) cards while also protecting the front and back surfaces of both their graded card casings and standard hard casings for the purpose of either personal display or for the purpose of sale.

In some embodiments, the disclosed case protectors may allow the graded card casings to enjoy one of their most appealing features, which is locking together like a puzzle when stacked one on top of one another. For example, a casing provided by a grading company typically is configured to allow cases to be stacked in an interlocking fashion, which makes transporting and handling the graded cards easier. Conventional sleeves that may be placed around a graded card case disable this feature as they obstruct the interlocking features. As a result, the sleeves allow the graded card casings to fall over much easier when being handled when stacked one on top of the other. It should be understood that while the disclosed protectors and kits described herein may be described with reference to a graded card casing, the disclosed protectors and kits are not so limited, as they may be configured to used in connection with any case or trading card sleeve. The disclosed casing protectors may also be configured to protect the hard card case sleeves in all variations from scratching and other damage.

In some embodiments, a single piece protector may be provided and/or used. For example, a single protector may be cut to fit and be placed on a first side (e.g., a front or back side) of a case. Another single-piece protector may be placed on a second side (e.g., the other of a front or back side) of a case. In some embodiments, a multiple-piece (e.g., two or more) protector may be used. In some embodiments, a first piece, which may be a front “card” piece, and a second piece, which a back “card” piece, is sized and configured to be placed on corresponding front and back sides of a case. In some embodiments, the protectors are provided in a pre-sized manner to fit a specific case. In some embodiments, the protectors may be provided in a kit with one or more stencils or guides to facilitate the cutting of a protector to a desired shape and/or size. In some embodiments, a height of the case protector(s) may be adjusted, whether front or back, when cutting a protector. However, it should be understood that the case protectors may be provided in different lengths and/or widths.

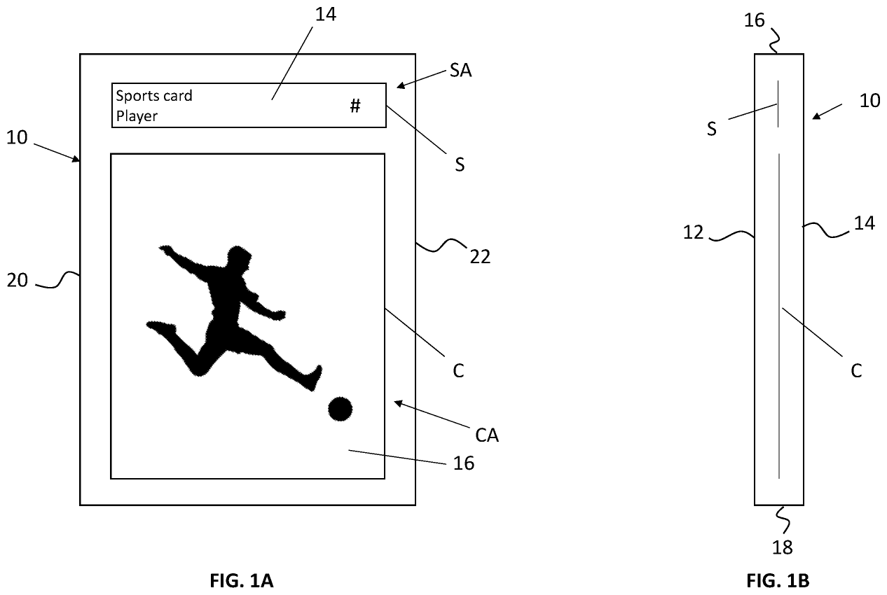

FIG. 1A is a front plan view of a card case 10, and FIG. 1B is a side view of the card case 10. The card case 10 may be a case provided by a grading company and encasing a card C. As shown in FIGS. 1A and 1B, the card C may be disposed within a case 10 having a first side 12, which may be a front side, and a second side 14, which may be an opposite or rear side. Case may further include a third side 16, which may be a top side, and a fourth side 18, which may be a bottom side. Opposed sides 20, 22 (e.g., left and right sides) may extend between the first and second sides 12, 14 and third and fourth sides 16, 18, as will be understood by one of ordinary skill in the art.

The card C may be any sort of collectible card (e.g., sports card, Pokemon card, or other trading card or collectible). However, it should be understood that the card C may be any graphical object that may be graded by a third party (e.g., card evaluator, auction house, authenticator, etc.), which may provide a case along with its grading or assessment of the card or object. In addition to encasing a card C, the case 10 may also encase a slab S. As will be understood by one of ordinary skill in the art, the slab S may include information concerning the card C, such as a grade, card description, name and/or identification of the third party. The slab S may be located in a slab area SA, which may be positioned adjacent to the card C located in a card area CA. It should be understood that the slab area SA may be disposed above, below, or on a left or right side of the card area CA. Depending on the case 10, the slab area SA and/or the card area CA may include a depression or protrusion to facilitate interlocking of multiple cases.

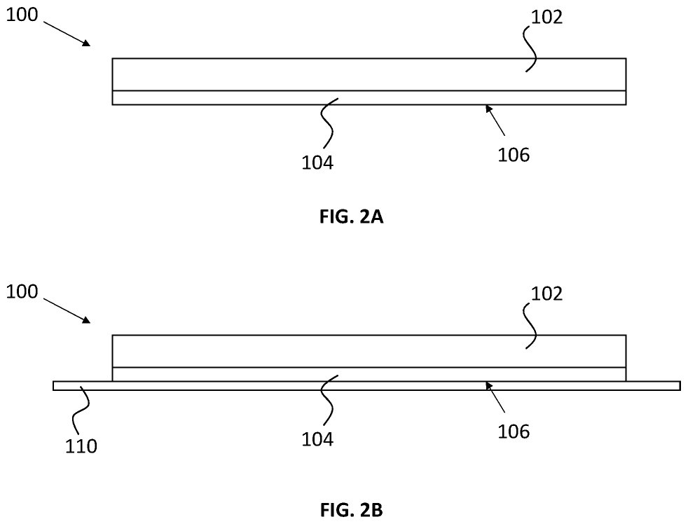

FIG. 2A illustrates one example of a protector 100 for protecting a case, such as case 10 illustrated in FIGS. 1A and 1B. Protector 100 may include a film or other protective material 102 having an adhesive 104 disposed on a case-facing side 106. In some embodiments, the protective material 102 includes a plastic material, such as those cellular phone removeable screen protectors made of polyethylene terephthalate (“PET”). The protective film 102 may be transparent such that a case 10 and a card C may be visible through the film 102 when the film 102 is coupled to (e.g., adhered to) the case 10. The material used may vary in that variations of plastic material or variations of different forms of tempered glass may be used to form and makeup each protector sheet 22. It should be understood that a transparency of the film 102 may vary. In some embodiments, the adhesive is a material configured to promote static adhesion to a case 10.

The protector 100 may be provided (e.g., sold or otherwise distributed) affixed to a carrier or substrate 110 as shown in FIG. 2B. The substrate 110 may be another piece of film from which the protective film 102 is formed. In some embodiments, the substrate 110 may be formed from a different material from which the protective film 102 is formed. In some embodiments, the substrate 110 may have at least one different dimension (e.g., length, width, thickness) from the protective film, as illustrated in FIG. 2A, although it should be understood that the substrate 110 may have the same dimensions as protective film 102. In some embodiments, a tab or other removal feature may be provided at a corner or along a length or width of the protector 100 to facilitate the removal of the substrate by a user. As will be understood by one of ordinary skill in the art, the removal feature may minimize touching of the adhesive 104 of the protector 100 when the protective film 102 is removed from the substrate 110.

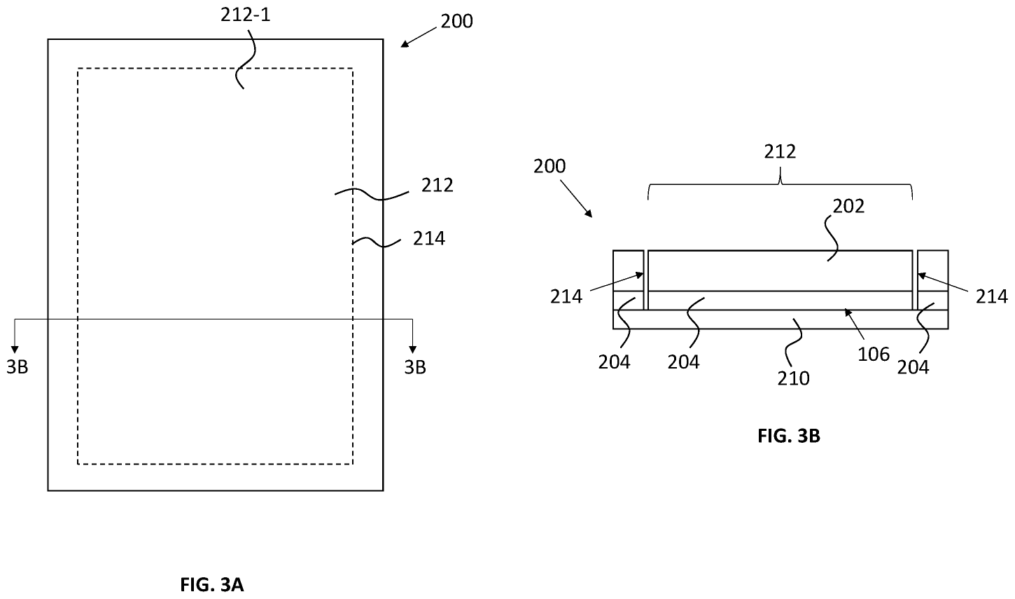

FIGS. 3A and 3B illustrate one example of a protector system in which a removable protective portion is provided on a substrate in accordance with some embodiments. The protector system 200 may include a protective film 202 coupled to a substrate 210 by an adhesive 204, as best seen in FIG. 3B. A single protective area 212 may be provided by cutting or perforating (e.g., mechanically, using a laser, or via other suitable means) the protective film 202. The perforation or cut 214 may extend entirely through the protective film 202 and adhesive layer 204, as best seen in FIG. 3B.

In the example illustrated in FIG. 3A, the protective area 212 may be sized and configured to protect an entire side of a card casing, such as side 12 casing 10 illustrated in FIGS. 1A and 1B, for example. However, it should be understood that the dimensions of the protective area 212 may have other dimensions, such as dimensions that are less than the length and width of the card casing 10. For example, the protective area 212 may be dimensioned to cover one or both of the slab area SA and the card area CA of the card casing 10 illustrated in FIGS. 1A and 1B. Although the perforation or cut 212 is illustrated as extending through the entirety of the protective film 202 and adhesive 204, it should be understood that the perforation or cut 214 may not extend through the entirety of one or more of the film 202 and/or adhesive 210. In some embodiments, the perforation or cut 214 may extend at least partially into the substrate 210, as will be understood by one of ordinary skill in the art.

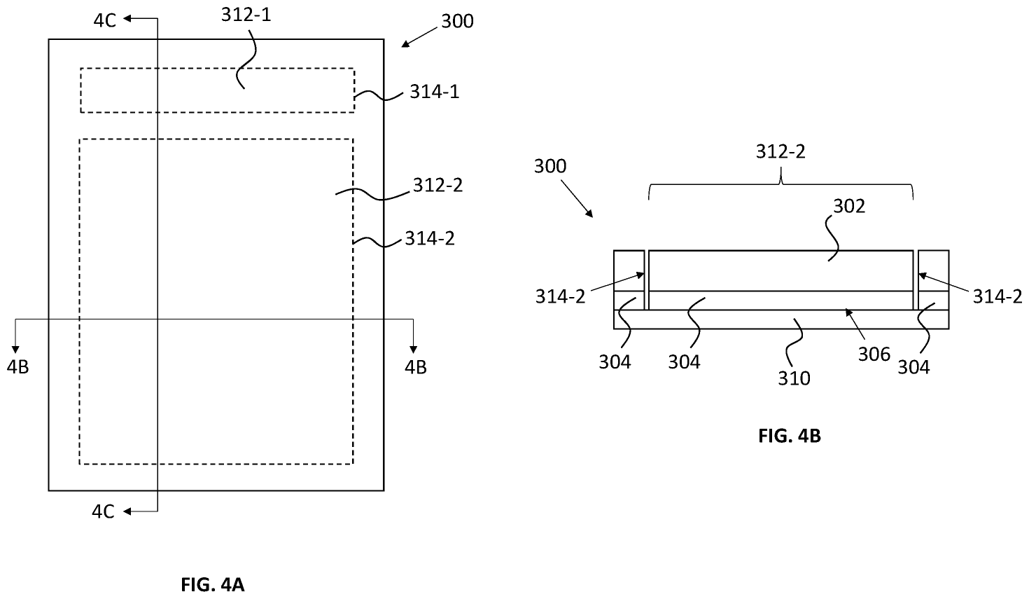

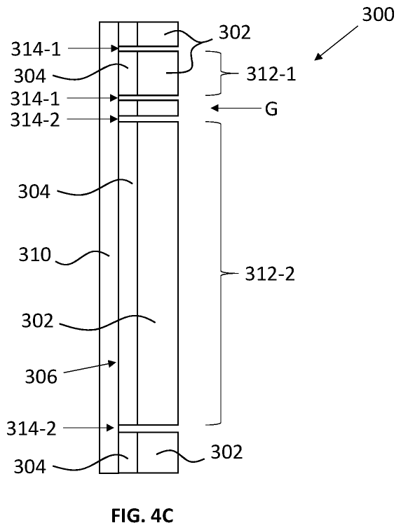

Although a single protective area 212 may be provided on a substrate 210, as illustrated in FIGS. 3A and 3B, it should be understood that multiple protective areas (e.g., two or more) may be provided on a substrate. FIGS. 4A-4C illustrate one example of a protector system in which multiple removable protective portions are provided on a single substrate. As shown in FIGS. 4A-4C, a protector system 300 may include a protective film 302 coupled to a substrate 310 by an adhesive 304, as best seen in FIGS. 4B and 4C. Protective areas 312-1, 312-2 may be provided by cutting or perforating (e.g., mechanically, using a laser, or via other suitable means) the protective film 302. The perforations or cuts 314-1, 314-2 may extend entirely through the protective film 302 and adhesive layer 304, as best seen in FIG. 4B.

In the example illustrated in FIG. 3A, the protective area 212-1 may be sized and configured to protect a slab area, such as the slab area SA illustrated in FIG. 1A, and protective area 212-2 may be sized and configured to protect a card area, such as card area CA illustrated in FIG. 1A, of a card casing 10. Although the perforations or cuts 314-1, 314-2 are illustrated as extending through the entirety of the protective film 302 and adhesive 304, it should be understood that the perforations or cuts 314 may not extend through the entirety of one or more of the film 302 and/or adhesive 310. In some embodiments, the perforation or cut 314 may extend at least partially into the substrate 310, as will be understood by one of ordinary skill in the art. Further, although the protective areas 314-1, 314-2 are shown as being separated from one another by a gap G in FIG. 4C, which may include a portion of the protective film 302 and adhesive 304, it should be understood that the gap G may be eliminated such that only a cut or perforation 314 separates the first protective area 314-1 and second protective area 314-2.

As shown in FIGS. 4A-4C, the protective areas 314-1, 314-2 have unequal dimensions (e.g., length and width), although protective areas 314-1, 314-2 may have equal dimensions. In some embodiments, the protective area 314-1 may be sized a configured to protect a slab area of a casing, such as slab area SA illustrated of the casing 10 illustrated in FIG. 1A, and the protective area 314-2 may be sized and configured to protect a card area of a casing, such as card area CA of the casing 10 illustrated in FIG. 1A. One of ordinary skill in the art will understand that any number of protective areas may be provided on a substrate, which may have different dimensions.

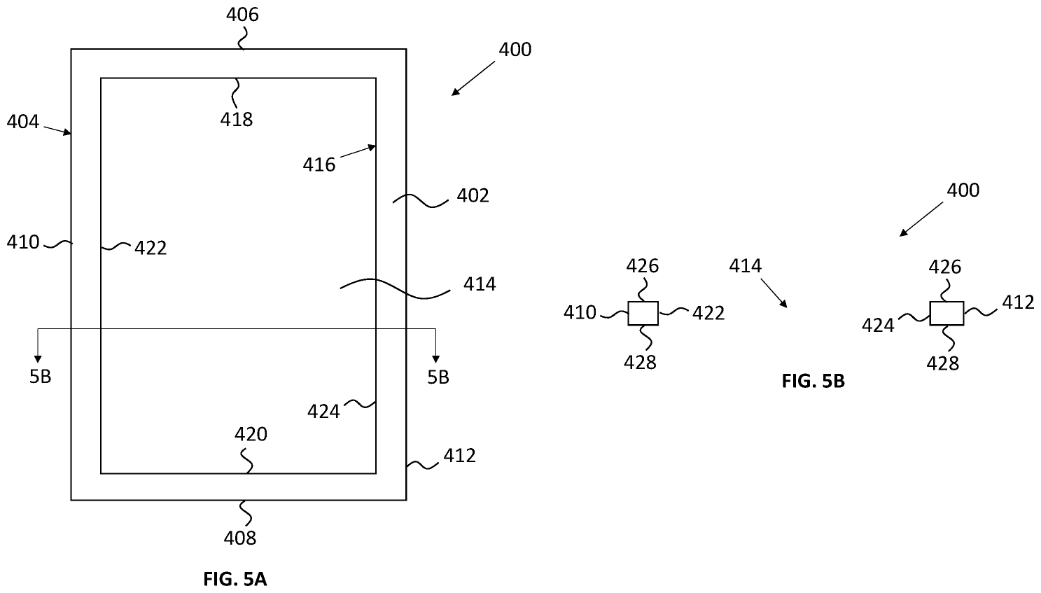

As noted above, a protector may be provided on a substrate that has equal length and width dimensions and without any cuts or perforations. In some embodiments, the protector may be sold in a kit along with one or more templates to facilitate the cutting or trimming of the protector to a predetermined size, which may correspond to a size of a commercially available casing. FIGS. 5A and 5B illustrate one example of a template that may be provided in a kit, in accordance with some embodiments.

As shown in FIGS. 5A and 5B, the template 400 may include a body 402, which may have an outer periphery 404. In the example illustrated in FIGS. 5A and 5B, the body 402 has a generally rectangular shape and the outer periphery 404 includes a first side 406, a second side 408, a third side 410, and a fourth side 412. Although outer periphery 404 is shown and described as having a generally rectangular shape, it should be understood that the outer periphery 404 may have other shapes, such as circular, triangular, polygonal, or arbitrary, which may correspond to a shape of an area of a casing to be protected. In some embodiments, the periphery 404 may be dimensioned to correspond to a size of an area of a casing to be protected, and thus the sides 406, 408, 410, 412 may be used as a cutting guide for a cutting or writing instrument (e.g., for drawing a line to facilitate cutting and/or trimming) as will be understood by one of ordinary skill in the art. Further, although sides 406, 408, 410, 412 of the periphery 404 are shown as being oriented at a right angles with respect to adjacent sides (e.g., top side 426 and bottom side 428), sides 406, 408, 410, 412 may be oriented at other angles (e.g., oblique angles) with respect to at least one of the top side 426 or the bottom side 428.

The body 402 may include an aperture or opening 414, which may be defined by an inner periphery 416. The inner periphery 416 also may have a generally rectangular shape, although inner periphery 416 may have other shapes, such as circular, triangular, polygonal, or arbitrary, which may correspond to a shape of an area of a casing to be protected. In the example illustrated in FIGS. 5A and 5B, the inner periphery 416 may include a first side 418, a second side 420, a third side 422, and a fourth side 424. In some embodiments, the periphery 404 may be dimensioned to correspond to a size of an area of a casing to be protected, and thus the sides 406, 408, 410, 412 may be used as a cutting guide for a cutting or writing instrument (e.g., for drawing a line to facilitate cutting and/or trimming) as will be understood by one of ordinary skill in the art. Further, although sides 418, 420, 422, 424 of the periphery 416 are shown as being oriented at a right angles with respect to adjacent sides (e.g., top side 426 and bottom side 428), sides 418, 420, 422, 424 may be oriented at other angles (e.g., oblique angles) with respect to at least one of the top side 426 or the bottom side 428.

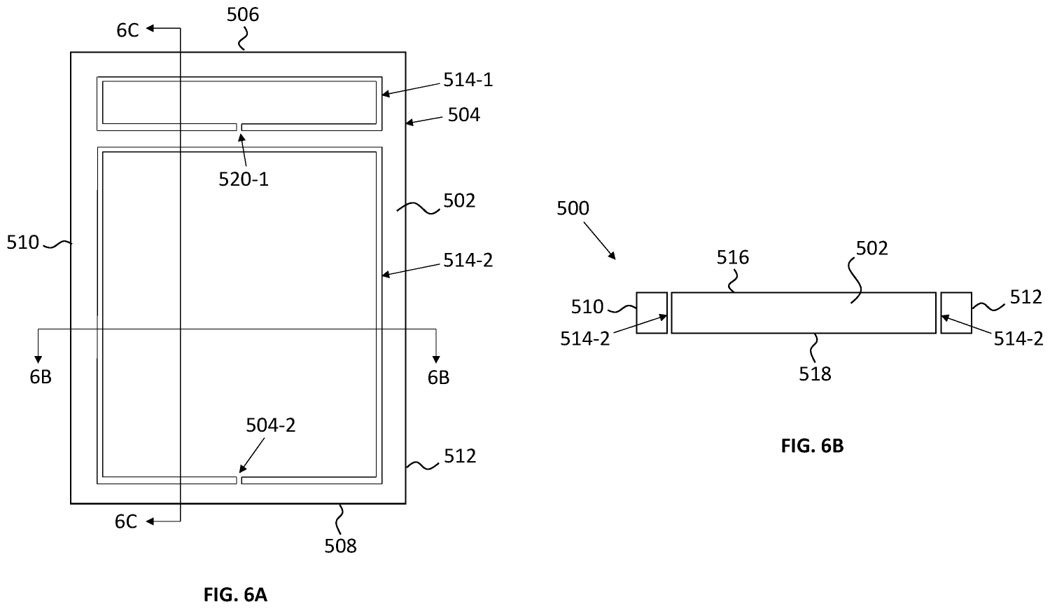

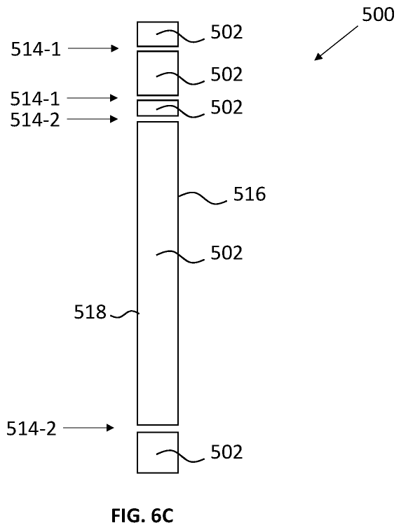

FIGS. 6A-6C illustrate another example of a template that may be provided in a kit, in accordance with some embodiments. As shown in FIGS. 6A-6C, the template 500 may include a body 502 having an outer periphery 504. In the example illustrated in FIGS. 6A-6C, the body 502 has a generally rectangular shape such that the outer periphery 504 includes a first side 506, a second side 508, a third side 510, and a fourth side 512. Although outer periphery 504 is shown and described as having a generally rectangular shape, it should be understood that the outer periphery 504 may have other shapes, such as circular, triangular, polygonal, or arbitrary, which may correspond to a shape of an area of a casing to be protected. In some embodiments, the periphery 504 may be dimensioned to correspond to a size of an area of a casing to be protected, and thus the sides 506, 508, 510, 52 may be used as a cutting guide for a cutting or writing instrument (e.g., for drawing a line to facilitate cutting and/or trimming) as will be understood by one of ordinary skill in the art.

Body 502 may define one or more guides for guiding a cutting and/or a writing instrument to facilitate the cutting or trimming of a protector. In the example illustrated in FIGS. 6A-6C, the body 502 defines a first guide 514-1 and a second guide 514-2 (collectively, “guides 514”), which may take the form of a channel or slot. The guides 514 may extend through the body 502 from a top side 516 to a bottom side 518, as best seen in FIGS. 6B and 6C. Although the walls of the body 502 that define the guides 514 are shown as being perpendicular with respect to the top side 516 and bottom side 518, the walls of the body 502 defining the guides 514 may be oriented at other angles (e.g., oblique angles) with respect to at least one of the top side 516 or the bottom side 518.

In some embodiments, the guides 514 may include one or more interruptions 520 along their length. For example, guide 514-1 may include an interruption 520-1, which couples together the inner and outer walls that define the guide 514-1, and guide 514-2 may include an interruption 520-2, which couples together the inner and outer walls that define the guide 514-2. Again, although a single interruption 520 is shown for each of the guides 514, each guide may include additional interruptions to increase the stability of the guides as will be understood by one of ordinary skill in the art.

The guides may be dimensioned to facilitate the cutting (or marking) of a protector that corresponds to an area of a casing to be protected. For example, the guide 514-1 may be dimensioned and arranged to facilitate the cutting (or marking) of a protector such that the resultant cut portion corresponds to a slab area of a casing, such as slab area SA of casing 10 illustrated in FIGS. 1A and 1B. Similarly, the guide 514-2 may be dimensioned and arranged to facilitate the cutting (or marking) of a protector such that the resultant cut portion corresponds to a card area of a casing, such as the card area CA of casing 10 illustrated in FIGS. 1A and 1B.

In use, a template 400, 500 may be placed over a protector, such as protector 100, and a cutting instrument (e.g., a knife or straight edge) may be used to cut or trim the protector to a desired size. In some embodiments, a written instrument, such as a pen, marker, pencil, chalk, etc., may be used to mark a cutting path guided by a template. A cutting instrument, such as a knife, straight edge, or scissor, may be used to cut the protector to the desired size by following the markings. Once the protector has been cut or trimmed to the desired size, the film 102 may be removed from the backing or substrate and then affixed to the corresponding area of the card casing.

In some embodiments, the disclosed case protectors may be sold on the marketplace in a single-piece configuration, a multi-piece configuration, and/or in a kit that may include one or more case protectors and one or more templates. For example, a case protector may be provided or sold with a single casing protector. The single casing protector may be sized and configured to cover only a single area of a casing (e.g., all or part of a front or back of a case) or it may be configured to cover multiple areas a casing protector (e.g., one or more slab areas and/or card areas on a front or back of a casing). In some embodiments, the dimensions of the multiple pieces for the front are identical to the multiple pieces for the back, although one of ordinary skill in the art will understand that the dimensions of the pieces for the front and the back may differ.

In some embodiments, kits may be provided within one or more protectors and one or more templates. Moreover, each kit may include one or more “wet wipes” and/or one or more “dry wipes” to clean the card casing set surface before adhering the unit set to the front and back of each case. Additionally, each kit may be packaged to include a card-like substance, with the size and rigid feel of a credit card, with those being used post-adhesion to displace and remove air pockets formed between the protector and the casing surface.

Although embodiments have been described in terms of exemplary features, they are not limited thereto. Rather, the appended claims should be construed broadly, to include other variants and embodiments, which may be made by those skilled in the art without departing from the scope and range of equivalents.

What is claimed is:

1. A protector, comprising:
a substrate; and
a first sheet of a first material supported by the substrate, the first sheet of a first material configured to be removed from the substrate and to be coupled to a casing for a collectable.

2. The protector of claim 1, wherein the first sheet of material is a plastic or a tempered glass.

3. The protector of claim 1, wherein the first sheet has a first length and a first width that corresponds to a length and a width of the casing.

4. The protector of claim 1, wherein the first sheet has a first length and a first width that corresponds to a length and a width of a first predetermined area of the casing.

5. The protector of claim 4, wherein the first area includes a slab area.

6. The protector of claim 5, wherein the first area includes a card area.

7. The protector of claim 3, wherein the first sheet includes at least one of a first perforation or a first cut, the at least one of the first perforation or the first cut at least partially enclosing a first protective area having a second length and a second width.

8. The protector of claim 7, wherein at least one of the second length and the second width is less than the first length and the first width.

9. The protector of claim 7, wherein the first protective area corresponds to a slab area of the casing.

10. The protector of claim 7, wherein the first protective area corresponds to a card area of the casing.

11. The protector of claim 7, wherein the first sheet includes at least one of a second perforation or a second cut, the at least one of the second perforation or the second cut at least partially enclosing a second protective area having a third length and a third width.

12. The protector of claim 11, wherein at least one of the third length and the third width is different from at least one of the second length and the second width.

13. The protector of claim 11, wherein the third length is the same as the second length, and wherein the third width is the same as the second width.

14. The protector of claim 1, wherein the first sheet of material is formed from a material selected from the group consisting of plastic and glass.

15. The protector of claim 1, wherein at least one of the first sheet of material or the substrate includes a removal feature configured to facilitate removal of the first sheet of material from the substrate.

16. A kit, comprising:
a protector including:
a substrate; and
a first sheet of a first material supported by the substrate, the first sheet of a first material configured to be removed from the substrate and to be coupled to a casing; and
a first template having a body including at least one surface configured to guide an instrument to facilitate cutting the protector.

17. The kit of claim 16, wherein the body of the template includes an outer periphery and an inner periphery, at least one of the outer periphery and the inner periphery including the at least one surface and having dimensions corresponding to a dimension of an area to be protected on a casing.

18. The kit of claim 17, wherein the area to be protected on the casing includes a slab area.

19. The kit of claim 17, wherein the area to be protected on the casing includes a card area.

20. The kit of claim 16, wherein the body of the template defines a first guide extending through the body from a first side to a second side, the guide including the at least one surface.

21. The kit of claim 20, wherein the guide at least partially encloses a first protective area having a first length and a first width.

22. The kit of claim 21, wherein the first length corresponds to a length of a first area of the casing to be protected and the first width corresponds to a width of the first area of the casing to be protected.

23. The kit of claim 22, wherein the first area to be protected includes a slab area of the casing.

24. The kit of claim 22, wherein the first area to be protected includes a card area of the casing.

25. The kit of claim 21, wherein the body of the template defines a second guide extending through the body from the first side to the second side and at least partially including a second protective area having a second length and a second width.

26. The kit of claim 25, wherein the at least one of the first length or the first width differs from the second length or the second width.

27. The kit of claim 25, wherein the first length is the same as the second length, and wherein the first width is the same as the second width.
